(19) United States
(12) Patent Application Publication
(10) Pub. No.: US 2023/0232786 A1
(43) Pub. Date: Jul. 27, 2023

(54) PET VEST

(71) Applicant: Suzhou Lingsuyi Trading Company Limited, Suzhou (CN)

(72) Inventor: Yangyi Han, Suzhou (CN)

(21) Appl. No.: 18/295,533

(22) Filed: Apr. 4, 2023

(51) Int. Cl. A01K 13/00

(52) U.S. Cl. CPC A01K 13/006

(57) ABSTRACT

A pet vest is provided, including a vest body, and the vest body includes a neck part, a back part, an abdomen part, and two leg parts. The vest body is provided with rivets, the back part of the vest body is provided with a zipper, the back part of the vest body is detachably connected with a back strap with spikes, the neck part of the vest body is detachably connected with a neck strap with spikes, and the neck part of the vest body is fixed with two D-shaped threading loops, and reflective strips are fixed on both sides of the abdomen part of the vest body. The present disclosure can protect pets from other aggressive dogs. Rivets help reduce daily wear and tear. Threading loops make walking the dog easier. Reflective strips can make pets clearly visible at night or in dark days.

### TECHNICAL FIELD

The present disclosure relates to the technical field of pet clothing, in particular to a pet vest.

### BACKGROUND

Many people in urban life like to raise pets, especially dogs. In order to better warm and protect their dogs, dog owners like to wear suitable clothes for their dogs. Vest is a commonly used clothing for dogs. Currently, dog vests in use only have the effect of keeping warm, but do not have the effect of safety protection. Small dogs often encounter injuries from some large dogs or other animals in the city.

### SUMMARY

The objectives of the present disclosure is to solve the defects existing in the prior art and to provide a pet vest.

In order to achieve the above objectives, the present disclosure adopts the following technical solutions:

A pet vest, which includes a vest body, wherein the vest body includes a neck part, a back part, an abdomen part, and two leg parts, the vest body is provided with rivets, the back part of the vest body is provided with a zipper, the back part of the vest body is detachably connected with a back strap with spikes, the neck part of the vest body is detachably connected with a neck strap with spikes, the neck part of the vest body is fixed with two D-shaped threading loops, and reflective strips are fixed on both sides of the abdomen part of the vest body.

Preferably, the vest body is made of waterproof fabric.

Preferably, the neck part, the abdomen part and the two leg parts of the vest body are provided with adjustable elastic bands.

Preferably, the back strap with spikes and the neck strap with spikes are respectively bonded to the vest body through velcro.

Preferably, two leg elastic ring is respectively provided at openings of the two leg parts, and configured for tightening gaps between the openings and legs of a pet to prevent debris or organisms harmful to the pet from entering the vest body from the legs.

Compared with the prior art, the advantageous effects of the present disclosure are as following:

In the present disclosure, the zipper is provided to facilitate to put on or take off the vest body from the pet. The back strap with spikes, the neck strap with spikes, and rivets can protect the pet from other aggressive dogs, wolves, owls, and eagles. At the same time, the sharp spikes of the back strap with spikes and the neck strap with spikes are made of very hard plastic, but they are not too sharp to harm the pet's skin, and the rivets can help reduce daily wear and tear. Threading loops make walking the dog easier. The reflective strips can make pets clearly visible at night or in dark days, so as to increase the safety of the pet. The vest body is made of waterproof fabric, which can keep pets dry and comfortable in rainy days. The neck part, the abdomen part and the two leg parts of the vest body are equipped with adjustable elastic bands, which can be better adjusted according to the size of the pet.

### BRIEF DESCRIPTION OF THE DRAWINGS

FIG. 1 is a front view of a pet vest proposed by the present disclosure;

FIG. 2 is a rear view of the pet vest proposed by the present disclosure;

FIG. 3 is a side view of the pet vest proposed by the present disclosure;

FIG. 4 is a top view of the pet vest proposed by the present disclosure;

FIG. 5 is a bottom view of the pet vest proposed by the present disclosure;

FIG. 6 is a first perspective view of a pet vest proposed by the present disclosure;

FIG. 7 is a second perspective view of the pet vest proposed by the present disclosure;

FIG. 8 is an enlarged partial view of position A in FIG. 7.

Reference numbers in the drawings: 1—vest body, 2—back strap with spikes, 3—neck strap with spikes, 4—zipper, 5—rivet, 6—reflective strip, 7—threading loop, 8—leg elastic ring.

### DETAILED DESCRIPTION OF THE EMBODIMENTS

The following will provide a clear and complete description of the technical solution in the embodiment of this present disclosure in conjunction with the accompanying drawings. Obviously, the described embodiment is only a part of the embodiment of this present disclosure, not the all embodiments.

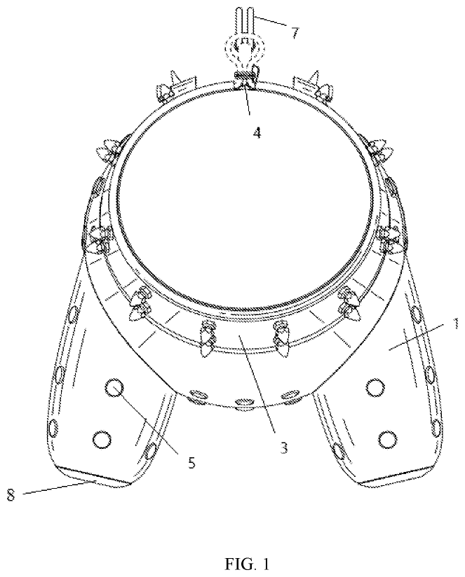

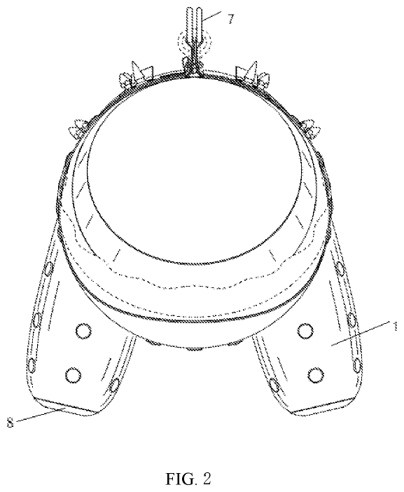

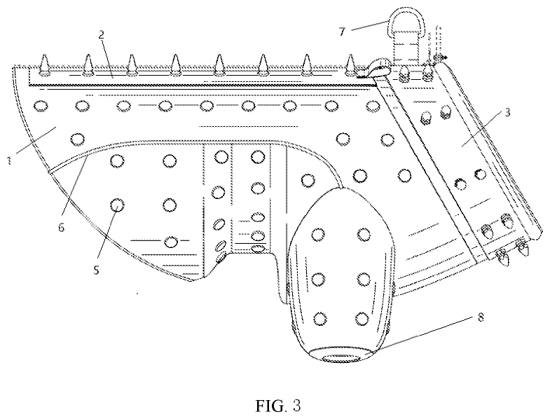

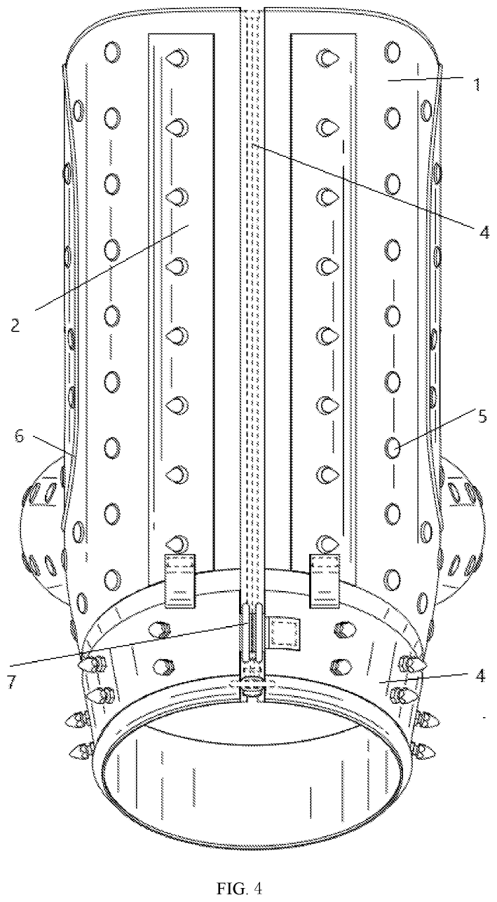

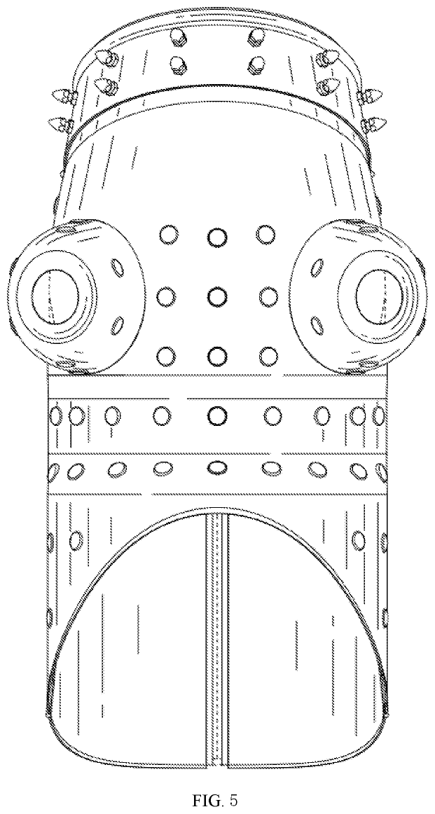

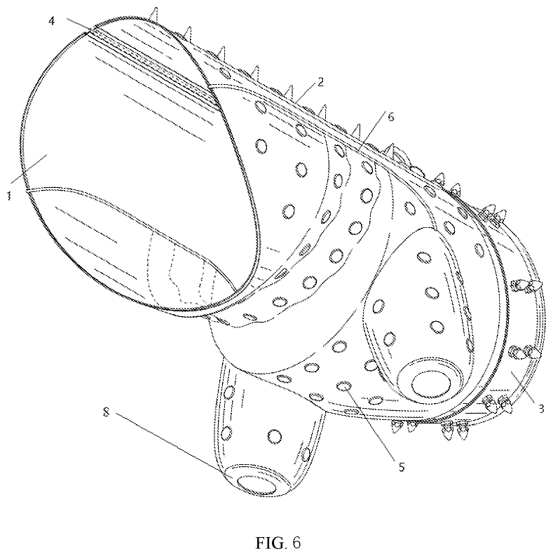

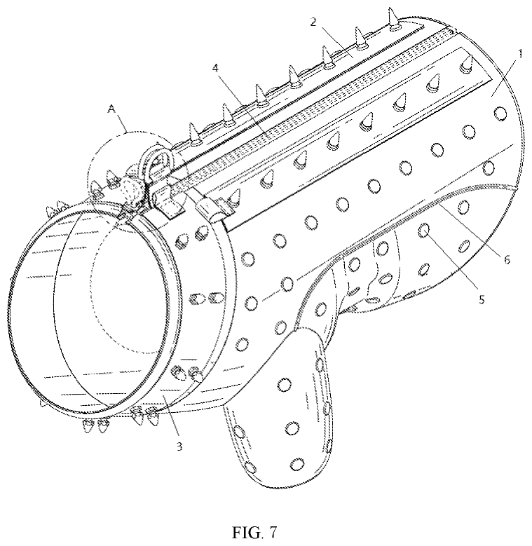

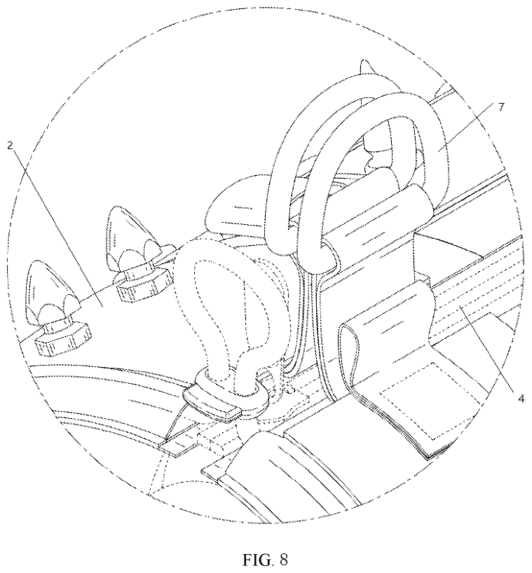

Referring to FIGS. 1-8, a pet vest includes a vest body 1, which includes a neck part, a back part, an abdomen part, and two leg parts. The vest body 1 is provided with rivets 5, and the back part of the vest body 1 is provided with a zipper 4. The zipper 4 is provided to facilitate the vest body 1 to put on or take off from the pet. The back part of the vest body 1 is detachably connected with a back strap with spikes 2, the neck part of the vest body 1 is detachably connected with a neck strap with spikes 3, and the back strap with spikes 2, the neck strap with spikes 3 and rivets 5 are provided to protect pets from other aggressive dogs, wolves, owls, and eagles. At the same time, the sharp spikes of the back strap with spikes 2 and the neck strap with spikes 3 are made of very hard plastic, but they will not be too sharp and harm the pet's skin. The rivets 5 help to reduce daily wear. The neck part of the vest body 1 is fixed with two D-shaped threading rings 7, which make it easier to walk the dog. The reflective strips 6 are fixed on both sides of the abdomen part of the vest body 1, which allow pets to be clearly visible at night or in dark days.

The vest body 1 is made of waterproof fabric, which can keep pets dry and comfortable in rainy days.

Adjustable elastic bands are installed on the neck part, the abdomen part, and the two leg parts of the vest body 1, allowing for adaptive adjustment for pets with different size, making them more comfortable and snug to wear. The leg elastic rings set at the openings of the two leg parts can not only wrap the pet's legs well to fit the pet's legs, but also tightening the gap between the openings of the two leg parts and the pet's legs, preventing debris or harmful organisms from entering the vest from the legs.

The back strap with spikes 2 and the neck strap with spikes 3 are respectively bonded to the vest body 1 through velcro, facilitating disassembly and assembly.

Working principle: The zipper 4 is arranged to facilitate to put on or take off the vest body 1 from the pet. The back strap with spikes 2, the neck strap with spikes 3, and the rivets 5 can protect the pet from other aggressive dogs, wolves, owls, and eagles. At the same time, the spikes of the back strap with spikes 2, and the neck strap with spikes 3 are made of very hard plastic, but they are not too sharp to harm the pet's skin. The rivets 5 help to reduce daily wear and tear, the threading loops 7 make it easier to walk the dog, the reflective strips 6 make pets clearly visible at night or in dark days. The vest body 1 is made of waterproof fabric, which can keep pets dry and comfortable in rainy days. The neck part, the abdomen part and the two leg parts of the vest body 1 are equipped with adjustable elastic bands, which can better adjust the size according to the pet.

The above description is only a preferred specific implementation of the present disclosure, but the scope of the present disclosure is not limited thereto. Any equivalent replacements or changes based on the technical solution and concept of the present disclosure made by the skilled person in the art, within the technical scope disclosed by the present disclosure, should be covered by the scope of the present disclosure.

What is claimed is:

1. A pet vest, comprising a vest body (1), wherein the vest body (1) comprises a neck part, a back part, an abdomen part, and two leg parts, characterized in that the vest body (1) is provided with rivets (5), the back part of the vest body (1) is provided with a zipper (4), the back part of the vest body (1) is detachably connected with a back strap with spikes (2), the neck part of the vest body (1) is detachably connected with a neck strap with spikes (3), the neck part of the vest body (1) is fixed with two D-shaped threading loops (7), and reflective strips (6) are fixed on both sides of the abdomen part of the vest body (1).

2. The pet vest according to claim 1, wherein the vest body (1) is made of waterproof fabric.

3. The pet vest according to claim 1, wherein the neck part, the abdomen part and the two leg parts of the vest body (1) are provided with adjustable elastic bands.

4. The pet vest according to claim 1, wherein the back strap with spikes (2) and the neck strap with spikes (3) are respectively bonded to the vest body (1) through velcro.

5. The pet vest according to claim 1, wherein two leg elastic ring is respectively provided at openings of the two leg parts, and configured for tightening gaps between the openings and legs of a pet to prevent debris or organisms harmful to the pet from entering the vest body (1) from the legs.
